(19) United States
(12) Patent Application Publication
(10) Pub. No.: US 2006/0280294 A1
(43) Pub. Date: Dec. 14, 2006

(54) Braille Mobile Phone

(75) Inventor: Qimao Zhang, Alexandria, VA (US)

Correspondence Address: Qimao Zhang, 5676 Ridge View Drive, Alexandria, VA, 22310, US

(73) Assignee: Qimao Zhang, Alexandria, VA (US)

(21) Appl. No.: 11/160,051

(22) Filed: Jun. 7, 2005

(51) Int. Cl. H04M 11/00

(52) U.S. Cl. 379/52

(57) ABSTRACT

Braille mobile phone is a mobile device provides integrated input and output in Braille to be used as a telephone, email and messaging system, Internet browser, calendar, clock and alarm, data storage and many other features. Telephone feature. User can use Braille Mobile Phone to place calls, end calls, and answering calls. The Braille Mobile Phone also has voice mail, numeric and text messaging, instant messaging, three-way calling, caller id, call forwarding, call waiting, and line blocking. Send and receive email. User can use Braille Mobile Phone to send and receive emails. The build-in software in the Braille Mobile Phone allows user to connect to mail server (such as Exchange server). Internet connection. User can use Braille Mobile Phone to browse the Internet. The build-in Internet browser allows user to browse mobile-device compatible web sites. For example, user can get directions or find out local attractions from a web site. Calendar. User can use the calendar feature to schedule appointment, find out the day, date, month, year information, and set up appointment alert. Clock and alarm. The Braille Mobile Phone has build-in system clock that can be adjusted to the local time zone. User can also set alarm on the device.
Data storage. The Braille Mobile Phone has build-in memory for data storage. For example, user can store a personal note or a novel on the phone and read it later.

| Term | Definition |
|---|---|
| Braille | a system of writing for the blind that uses |
| | characters made up of raised dots |
| Braille Display | a display panel with many rows and columns of |
| Panel | Braille cells to display Braille text. User can |
| | read the text by touching each Braille cell |
| | sequentially. |
| Braille Keyboard | has many Braille keys. Each Braille key has |
| | embossed dots on the key to represent a Braille |
| | character or word. |
| Braille Mobile | is a mobile device that allows blind users to |
| Phone | perform telephony functions, connect to the |
| | Internet, send and retrieve emails and message, |
| | store data, and benefit from other mobile services. |
| Email | a means or system for transmitting messages |
| | electronically (as between computers on a network) |
| Exchange Server | A messaging system including mail server, email |
| | client and groupware applications (such as |
| | shared calendars). |
| Internet Browser | An Internet browser is a program that is |
| | installed on your PC or mobile device to enable |
| | you to access the information on the Internet. |
| Voice Mail | an electronic communication system in which |
| | spoken messages are recorded or digitized for |
| | later playback to the intended recipient |

Braille mobile phone is a mobile device that provides multiple mobile services using Braille keyboard and Braille display panel. Blind and visually impaired people can use Braille mobile phone to perform many functions such as telephone services, email and Internet access, text messaging, clock and alarm, and data storage.

Braille mobile phone has Braille keyboard and Braille display panel. The Braille keyboard allows user to provide input by press on a Braille key. Each Braille key has embossed dots on the key. The Braille display panel has many rows and columns of Braille cells. Each Braille cell has six embossed mechanical dots arranged in two vertical rows of three dots each. Each mechanical dot can move up and down by the mechanical arm under it. The Braille cell is capable to display any Braille character. The Braille Display panel can refresh itself at constant interval (such as 30 times per minute) or at each key press.

Braille mobile phone serves as a cell phone and pocket PC for the blind and visually impaired users. Braille mobile phone can be easily carried almost everywhere because it is portable and light-weight. Since it is connected to the phone system, Internet and email system, it can provide user with very useful information anywhere and anytime.

What is claimed is:

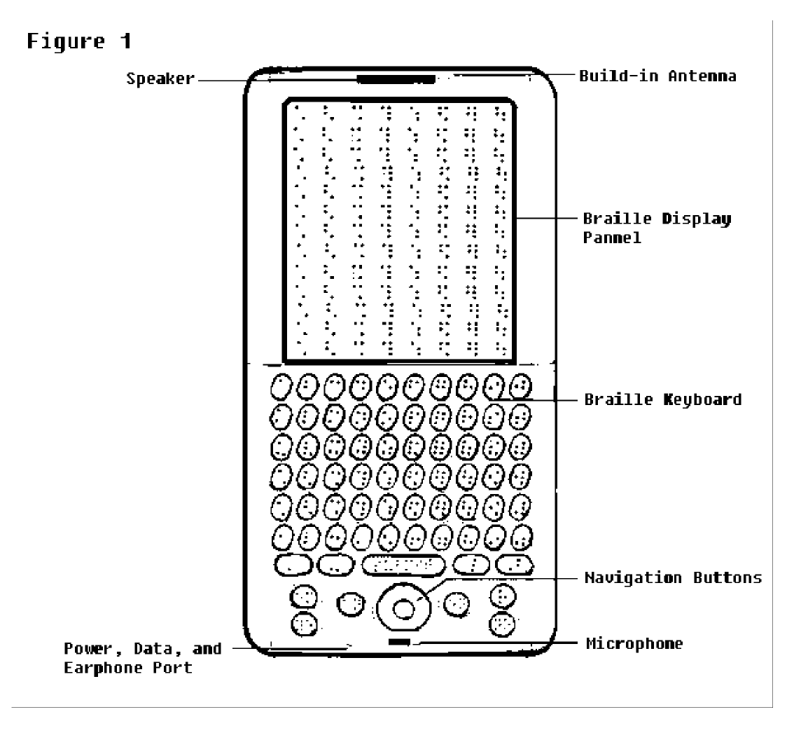

1. Braille mobile phone provides mobile services using Braille keyboard and Braille display panel. Braille mobile phone is a mobile device that sends and receives wireless signals (see FIG. 1).

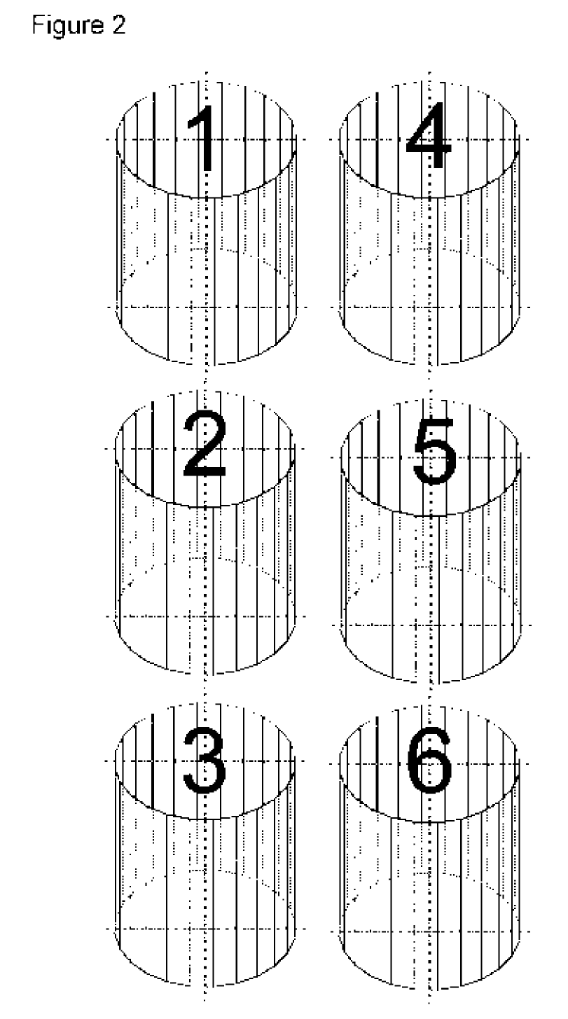

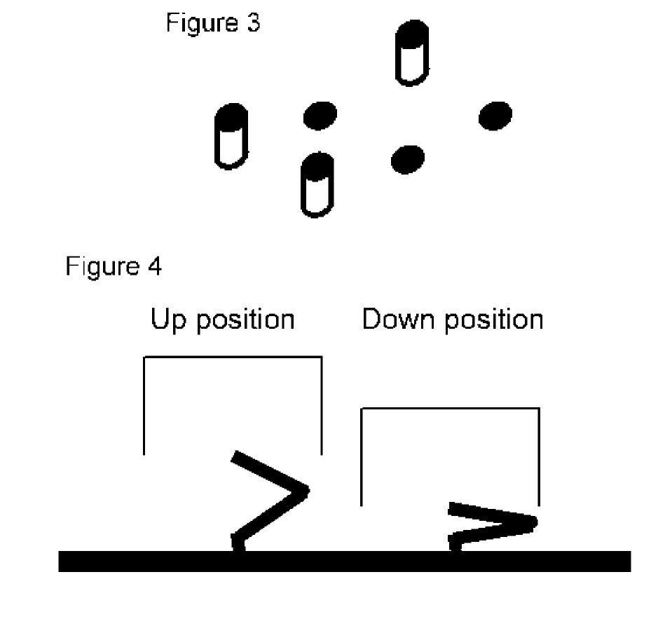

2. Braille mobile phone converts digital signal into Braille letters and displayed in the Braille display panel. The Braille display panel contains many Braille display cells. Each Braille display cell has six embossed mechanical dots arranged in two vertical rows of three dots each. The first vertical row contains dot 1, 2, and 3. The second vertical row contains dot 4, 5, and 6 (see FIG. 2). These raised dots are used to display Braille letters of alphabet, numbers, contractions, marks of punctuation, and entire words. For example, letter “u” is dots 1-3-6 (see FIG. 3).

3. Braille mobile phone has build-in software to convert the text output into display signals for each Braille dot. For any Braille dot, there are two vertical positions, up and down (see FIG. 4). The mechanical arms will move up and down the Braille dot.

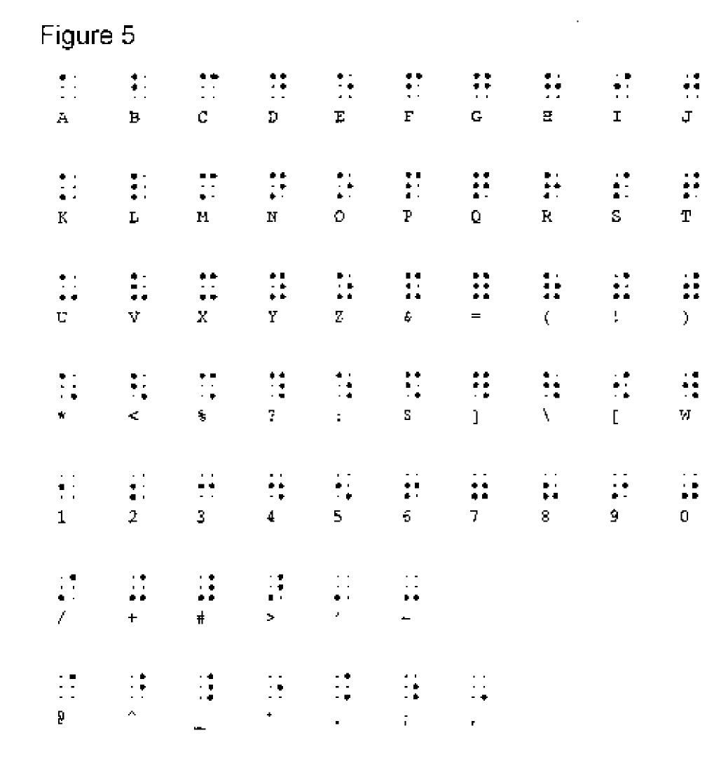

4. Braille mobile phone contains Braille keyboard with embossed dots for each key. The Braille keyboard has all the letters of alphabet, numbers, contractions, marks of punctuation (see FIG. 5). In addition, the Braille keyboard has important mobile device keys such as Navigation (up, down, left, right), Answer, End, Yes, No, Email, and Redial.

5. The Braille display panel refreshes itself after each key stroke on the key board or at a constant time intervals.

6. Braille mobile phone has speaker, microphone, and power, data, and earphone port.
